(19) United States
(12) Patent Application Publication
(10) Pub. No.: US 2006/0040665 A1
(43) Pub. Date: Feb. 23, 2006

(54) Method for automatically switching the dialing network of dual-mode mobile phone

(75) Inventors: Cheng-Shing Lai, Taipei (TW); Xiao-Long Fan, Nanking (CN); Ping Gu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/136,547

(22) Filed: May 25, 2005

(30) Foreign Application Priority Data
Aug. 11, 2004 (TW) 093124013

(51) Int. Cl. H04M 1/00; H04Q 7/20

(52) U.S. Cl. 455/435.2; 455/552.1

(57) ABSTRACT

The present invention is to provide a method, which employs a detection control software installed in a dual-mode mobile phone of the GSM network communication system and the low power PHS network communication system, so as to automatically detect the dialing network service area of the best communication rate, when the dual-mode mobile phone enters into a selection mode for automatically switching to the optimized dialing network in a time period, and then dial out via the detected dialing network service area of the best communication rate after a dialing message is received. Thus, the users of the dual-mode mobile phones can enjoy the low communication rate, which will largely reduce the cost of their phone bills.

### FIELD OF THE INVENTION

The present invention relates generally to a wireless communication device, more particularly to a method of increasing a selection mode in a dual-mode mobile phone for automatically switching dialing networks through a detection control software installed therein and automatically selecting an optimal dialing network with the best communication rate, at the time the mobile phone is dialed, to largely reduce the cost of phone bills thereof.

### BACKGROUND OF THE INVENTION

The development of science and technology in the contemporary society has generated an explosive amount of information and knowledge. The coming of the network era renders communication and exchange of information between people a more and more important issue. The network and communication technologies, such as mobile communication and wireless communication, have been rapidly and widely spread to the daily life of modern people. Therefore, wireless communication devices, such as cellular phones or mobile phones, have become one of the most important and irreplaceable tools of modern people.

In recent years, the mobile phone has widely adopted the Global System for Mobile Communication (GSM) as its primary communication protocol. However, the GSM communication system produces radiation of relative high power, which is very harmful to human health. On the other hand, the GSM communication system charges its user for receiving phone calls. Recently, a low power communication system, called Personal Handyphone System (PHS), has been developed and gradually gained its popularity. The functions of such low power communication system are basically similar to the GSM communication system. The primary difference is in that the PHS communication system employs micro-cell base stations to send and receive signals, the coverage range of which is smaller, while the motion speed is also slower. For this reason, the PHS communication system is more suitable for people living in a metropolitan area. Although the cost for using the PHS system is lower, its usage is only limited in a limited geographical range, which can not satisfy some people's need. Therefore, a so-called “dual-mode mobile phone” has been emerged. The “dual-mode mobile phone” is a mobile phone that can use both the GSM communication system and the low power PHS communication system.

Currently, the “dual-mode mobile phone” requires user to select the usage mode and configure the selected mode. The usage modes usually include a single mode of the GSM network communication system as described above, a single mode of the low power PHS network communication system, and a double mode of GSM/PHS network communication systems to be determined according to the priority sequence of the dialing network.

However, in practice, the system service providers often promote discount packages for all types of services, regardless of whether the user selects the GSM single mode, the low power PHS single mode, or the GSM/PHS double mode to be determined according to the priority sequence of the dialing network. For instance, during some certain promotion period, the service of GSM network communication system is cheaper than that of the low power PHS network communication system.

Moreover, since the quality of mobile phones from different manufacturers is gradually equalized, only distinctive feature in a mobile phone can win commercial success in the market. Therefore, a mobile phone that can automatically switch between the most optimized network modes is believed to be the distinctive feature that can win commercial success. Meanwhile, the users of such mobile phones can largely reduce the cost of their phone bills.

### SUMMARY OF THE INVENTION

In light of the prior art description given above, one can easily conceive the commercial demand of a “dual-mode mobile phone”. However, since the service providers often offer all kinds of promotion discount packages, the GSM network communication system may be cheaper than the low power PHS network communication system in certain time periods. Therefore, based on the long term request from the users and the market demands, the inventors of the present invention have devoted themselves in the study and experimentation of the dual-mode mobile phones. Finally, the problems of the conventional dual-mode mobile phone have been solved and a new method for automatically switching the optimized dialing network modes of a dual-mode mobile phone has been developed. Accordingly, the users of dual-mode mobile phones can largely lower the cost of their phone bills.

It is an object of the present invention to provide a method that can automatically detect whether the mobile phone is located in the dialing network service area of the best communication rate at the time the mobile phone is dialed. The method employs a detection control software installed in a dual-mode mobile phone of the GSM network communication system and the low power PHS network communication system, so as to automatically detect the dialing network service area of the best communication rate, when the dual-mode mobile phone enters into a selection mode for automatically switching to the optimized dialing network in a time period. Later, the mobile phone dials out via the detected dialing network service area of the best communication rate, after a dialing message is received. Once the mobile phone leaves the dialing network service area of the best communication rate, the mobile phone will dial via the other network service area in the next dialing process, so as to prevent the dialing function of mobile phone from being disabled. In this manner, the users can enjoy the low communication rate, which will largely reduce the cost of their phone bills.

It is another object of the present invention to provide a method that is advantageous in the following aspects:
1. The detection of dialing network service area of the best communication rate is automatically performed by the detection control software installed in the mobile phone. No manual operation of the mobile phone is required.
2. By employing the detection control software, the occasion of no dialing network service will be prevented from happening.
3. The cost of users phone bill is lowered.
4. Using the detection control software within the mobile phone, one can reduce the time required to search for the network service area. Consequently, the power consumption of the mobile phone is reduced.
5. This distinctive feature can enhance the commercial value of the mobile phone and attract more potential buyers.

The above and other objects, features and advantages of the present invention will become apparent from the following detailed description taken with the accompanying drawings.

### BRIEF DESCRIPTION OF THE DRAWINGS

FIG. 1 is a flow diagram illustrating the process for detecting the dialing network service that offers the best rate when turning on the mobile phone.

### DETAILED DESCRIPTION OF THE PREFERRED EMBODIMENTS

The present invention provides a method for automatically switching to an optimized dialing network mode of a dual-mode mobile phone. The dual-mode mobile phone having the GSM network communication system and the low power PHS communication system comprises a detection control software. The detection control software can automatically detect a dialing network service that offers the best communication rate when the dual-mode mobile phone enters into a selection mode for automatically switching to the optimized dialing network. After the dialing network service that offers the best rate is detected and a dialing message is received, the mobile phone then performs the dialing process via the dialing network service of the best rate. In this manner, the users can enjoy the low communication rate, which will largely reduce the cost of their phone bills.

In the present invention, the mobile phone stands by under the double mode of GSM network communication system and the low power PHS network communication system after the mobile phone is turned on. When the mobile phone enters into the selection mode for automatically switching to the optimized dialing network, the detection control software automatically detects whether the mobile phone is located within a dialing network service area of the best communication rate. If the mobile phone is located in the dialing network service area of the best communication rate, and a dialing message is received, the mobile phone will dial out via the dialing network service area of the best communication rate, so as to lower the cost of phone bill. Once the mobile phone leaves the dialing network service area of the best communication rate, the mobile phone will automatically dial out via another network service area at the next dial, thereby preventing the dialing of mobile phone from being disabled.

Furthermore, since each individual service provider offers different promotion packages, the user needs to input and configure the communication rate promotion packages for the time intervals described above. This includes the promotion packages for both the GSM network communication system and the PHS network communication system.

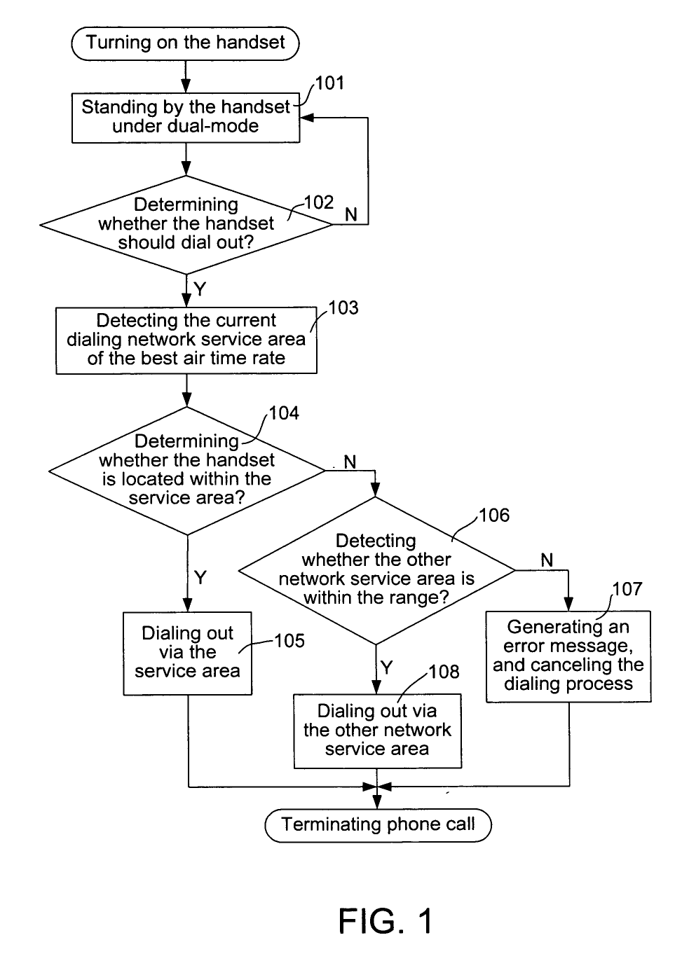

Hereinafter, one particular embodiment of the present invention is described in detail by incorporating with the accompanying drawings. Referring to FIG. 1, when the mobile phone is turned on, the detection control software performs the following steps:

First, in step 101, the mobile phone stands by under the double mode of GSM network communication system and the low power PHS network communication system, and enters into the selection mode for automatically switching to the dialing network of the best communication rate.

Then, in step 102, the detection control software determines whether the mobile phone should dial out. If not, then return the process to the step 101 and continuously stand by the mobile phone under the double mode. If yes, then perform the next step 103.

In step 103, the detection control software detects the dialing service area of the best communication rate. In this particular embodiment, the dialing network service area of the best communication rate is presumably the GSM network communication system.

In step 104, after confirming the dialing network service area being the one having the best communication rate, the detection control software determines whether the dialing network service area (i.e. the GSM network communication system) is online or within the network service area. If yes, then continue to step 105. If not, then go to step 106.

In step 105, the mobile phone dials out a phone call via the dialing network service area of the best communication rate (i.e. the GSM network communication system), and then ends the process.

In step 106, the detection control software further detects whether the other network service area is online or within the network service area. In this particular embodiment, the other network service area is presumably the low power PHS network communication system. If the other network service area is not online or within the network service area, then continue to step 107; otherwise, go to step 108.

In step 107, an error message is generated, and then the dialing process is canceled.

In step 108, the mobile phone dials out via the other network service area (i.e. the low power PHS network communication system), and then ends the process.

Accordingly, the user can enjoy the lower communication rate by repeating the method steps described above, thereby lowering the cost of phone bills. Therefore, the present invention is beneficial for the general public.

While the invention has been described by means of specific embodiments, numerous modifications and variations could be made thereto by those skilled in the art without departing from the scope and spirit of the invention set forth in the claims.

What is claimed is:

1. A method for automatically switching dialing network modes of a dual-mode mobile phone, the mobile phone comprising a detection control software, which enters into a selection mode for automatically switching to an optimized dialing network, said method comprising the steps of:
automatically detecting a dialing network service area of best communication rate;
dialing the mobile phone via the detected network service area of the best communication rate after receiving a dialing message therefrom.

2. The method of claim 1, further comprising a step of inputting and configuring the time intervals in the mobile phone for the best communication rates.

3. The method of claim 1, wherein the step of automatically detecting the dialing network service area of the best communication rate further comprises the steps of:
standing by the mobile phone under a double mode, and entering into the selection mode for automatically switching to the optimized dialing network;
receiving a dialing message issued from the dialing network service area;
detecting the dialing network service area of the best communication rate;
dialing the mobile phone via the detected dialing network service area of the best communication rate, after confirming the dialing network service area of the best communication rate is online or within the network service area.

4. The method of claim 3, further comprising the steps of:
detecting the other network service area when the dialing network service area of the best communication rate is not online nor within the network service area;
dialing the mobile phone via the other network service area when the other dialing network service area of the best communication rate is online or within the network service area.

5. The method of claim 4, further comprising the step of generating an error message and canceling the dialing process when the other network service area is not online nor within the network service area.

6. The method of claim 1, wherein the double mode comprises a GSM network communication system and a low power PHS network communication system.
